(19) United States
(12) Patent Application Publication
(10) Pub. No.: US 2006/0173782 A1
(43) Pub. Date: Aug. 3, 2006

(54) Data access methods, media repository systems, media systems and articles of manufacture

(76) Inventor: Ullas Gargi, San Jose, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/049,925

(22) Filed: Feb. 3, 2005

(51) Int. Cl. G06F 17/60

(52) U.S. Cl. 705/51

(57) ABSTRACT

Data access methods, media repository systems, media systems and articles of manufacture are described. According to one embodiment, a data access method includes storing media content using a media repository system and wherein a plurality of different usage rights are provided for controlling the consumption of the media content, providing a client configured to consume the media content, using the media repository system, accessing location information regarding a location of the client, using the location information, selecting one of the usage rights, communicating the media content to the client using the media repository system, and using the client, consuming the media content in accordance with the one of the usage rights.

### TECHNICAL FIELD

Aspects of the disclosure relate to data access methods, media repository systems, media systems and articles of manufacture.

### BACKGROUND OF THE DISCLOSURE

In recent decades, the amount of information available as digital content has increased substantially. The advantages of digital content over analog formats, for example, have been readily recognized and accepted by consumers and digital content is ubiquitous and the preferred format for consuming media. Unfortunately, the nature of digital content makes it readily available for one to make exact unauthorized copies of copyrighted or licensed works.

Digital Rights Management (DRM) has been developed to provide security and encryption for combating unauthorized copying. The aim of DRM is to “lock” the content of the work and limit its distribution to authorized users. DRM has more recently been expanded to address description, identification, trading, protection, monitoring and tracking of all forms of rights usages over both tangible and intangible works.

Some existing DRM access solutions use user access rights and authentication by a server to determine usage rights to digital content. Although these DRM solutions are suitable, in practice, DRM has not been readily accepted in the marketplace because users have been generally unwilling to pay the increased cost in terms of complexity, obtrusiveness, and unwieldiness.

In other conventional arrangements, region codes (e.g., DVD applications) are utilized in an attempt to control access to content of the media. For example, the player and DVD disc have the same region code for playback to work. However, DVD region codes have disadvantages of being relatively limited, static and course. There is a need to provide less cumbersome systems and methods for controlling access and which are more transparent than existing solutions.

At least some aspects of the disclosure are directed toward methods and apparatus for implementing control and/or management of usage rights with respect to data content.

### SUMMARY

According to some aspects, data access methods, media repository systems, media systems and articles of manufacture are described.

According to one aspect, a data access method comprises storing media content using a media repository system and wherein a plurality of different usage rights are provided for controlling the consumption of the media content, providing a client configured to consume the media content, using the media repository system, accessing location information regarding a location of the client, using the location information, selecting one of the usage rights, communicating the media content to the client using the media repository system, and using the client, consuming the media content in accordance with the one of the usage rights.

According to another aspect, a media repository system comprises storage circuitry configured to store media content of a plurality of media data items, a communications interface configured to communicate the media content of a selected one of the media data items to a client, and processing circuitry configured to access location information regarding a location of the client, to identify one of the media data items to be accessed by the client, to select one of a plurality of different usage rights responsive to the location information and configured to control the consumption of media content of the one of the media data items, and to control the communications interface to communicate the media content of the one of the media data items to the client for consumption in accordance with the one of the usage rights.

Other embodiments and aspects are described as is apparent from the following discussion.

### DESCRIPTION OF THE DRAWINGS

FIG. 1 is a functional block diagram of a media system according to one embodiment.

FIG. 2 is a functional block diagram of a media repository system according to one embodiment.

FIG. 3 is a functional block diagram of one implementation of circuitry of the media repository system according to one embodiment.

FIG. 4 is a flow chart of an exemplary method performed by the media repository system according to one embodiment.

FIG. 5 is a flow chart of an exemplary method performed by a client according to one embodiment.

### DETAILED DESCRIPTION

At least some aspects of the disclosure are directed towards controlling the access and dissemination of media content. For example, a repository may selectively enable requesting clients to access and consume one or more media data items of the media content provided by the repository in accordance with respective usage rights of the client. The access of the clients to the media content by the usage rights may be dynamic in at least some configurations and in one embodiment based upon location information of the respective clients.

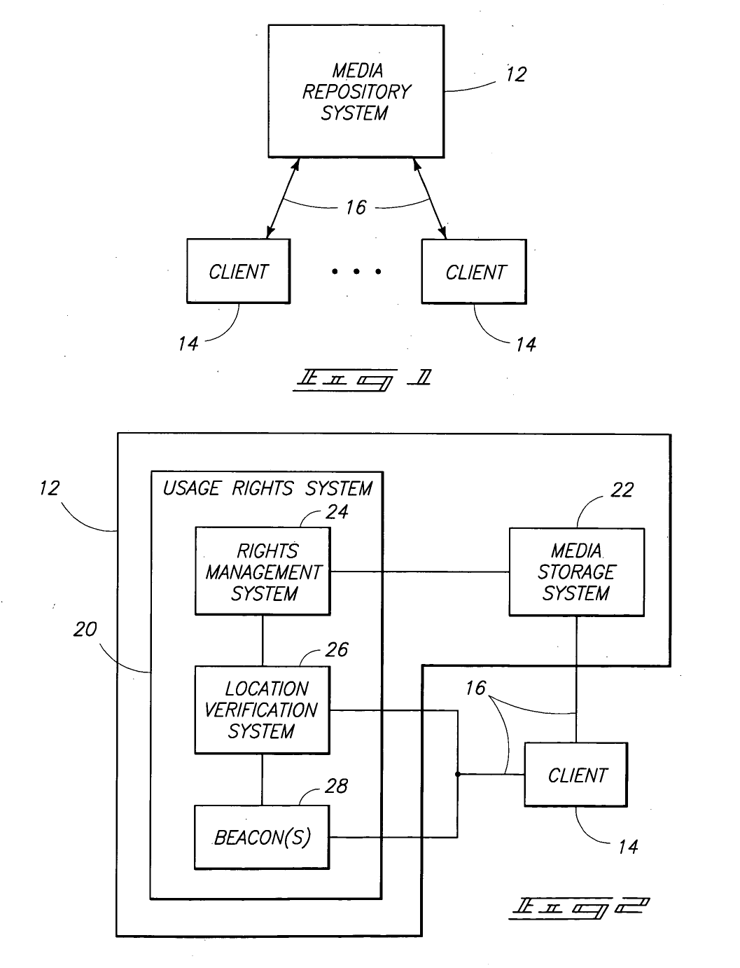

Referring to FIG. 1, an exemplary media system 10 for disseminating and consuming media content is shown according to one embodiment. The exemplary media system 10 includes a media repository system 12 and one or more client 14. Media repository system 12 is configured to store media content and to process requests with respect to access of clients 14 to the media content. Responsive to the processing and analysis of requests, media repository system 12 may permit respective clients 14 to access and consume desired media content (e.g., one or more of the media data items) according to respective determined usage rights. As mentioned, location information of individual clients 14 may be used to determine usage rights and to control the access of clients 14 to the media content.

Media repository system 12 is configured to store and, when appropriate, disseminate media content which may comprise a plurality of media data items in one embodiment to one or more clients 14. Exemplary media data items include songs, compact disks, DVD data, photographs, software, electronic games and any other data content which may be consumed (e.g., the content may be played, illustrated, copied or otherwise communicated to or manipulated by a user) by one or more of clients 14 in accordance with respective usage rights. Additional details regarding an exemplary embodiment of media repository system 12 are described below.

Clients 14 are devices which may be associated with respective users and are configured to consume media content of one or more of the media data items stored within media repository system 12. Clients 14 may be implemented in various electronic device configurations and may include personal computers, notebook computers, cellular telephones, personal digital assistants (PDAs), game counsels, televisions, cameras, or other configurations capable of consuming the media content being accessed.

Clients 14 may be configured to communicate with media repository system 12 via a plurality of data connections 16. Data connections 16 may be implemented using wired and/or wireless media and may comprise network connections (e.g., private, public, Internet Protocol, LAN, Ethernet and/or others suitable to transfer data) in one embodiment. As described below, individual data connections 16 are illustrative to represent communications between media repository system 12 and respective clients 14 and may include more than one connection with respect to an individual client 14. Different clients 14 may be configured differently. For example, some clients 14 may be configured to provide location information on their own (e.g., via a GPS sensor) or by using infrastructure of usage rights system 12 (e.g., beacons 28 described below).

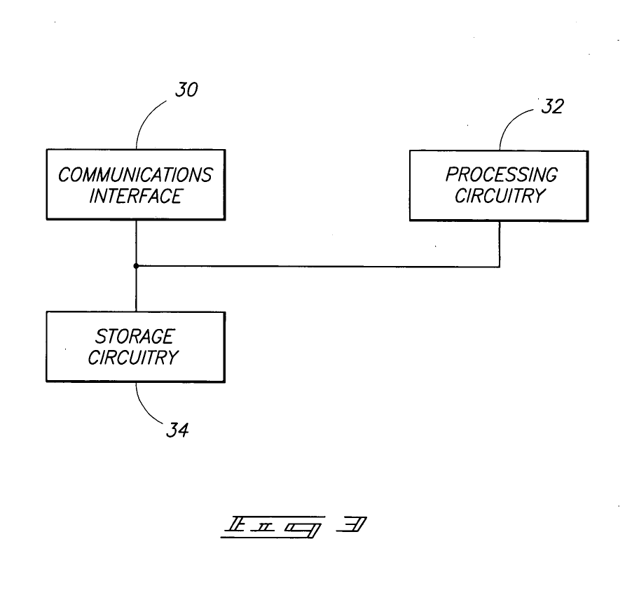

Referring to FIG. 2, additional details are described regarding an exemplary embodiment of media repository system 12. The exemplary system 12 may include a usage rights system 20 and a media storage system 22 which may be configured as respective servers in one implementation.

In one example wherein usage rights may be based upon location information of a requesting client 14, usage rights system 20 may include a rights management system 24, a location verification system 26 and one or more beacons 28 in one possible embodiment. In other embodiments, more, less or alternative components may be provided. For example, in some embodiments, location verification system 26 and beacons 28 may be omitted. In addition, aspects described below with respect to systems 22, 24, 26 and beacons 28 may be implemented in other structure in other embodiments (e.g., beacons 28 may be configured to internally validate locations of clients 14 in high volume applications).

Media storage system 22 is configured to store media content which may include one or more media data item and to implement communications via data connection 16 with respect to one or more client 14. Media storage system 22 may include any appropriate system for providing media content to one or more client 14 and may be implemented as a media jukebox in but one illustrative embodiment. The data connection 16 intermediate client 14 and media storage system 22 may be implemented to receive requests from client 14; to access any additional information for providing media content to client 14, and to stream or otherwise communicate appropriate media content to client 14.

Rights management system 24 may be configured to map or otherwise associate usage rights with a requested media data item to control access and consumption of the media data item by a requesting client 14. In one embodiment, the rights management system 24 is configured to discern the usage rights based upon location information of a respective client 14. The location information may correspond to locations of the respective requesting clients 14 at the moments in time that the clients 14 are desirous of obtaining the media content. Exemplary location information may include absolute location information (e.g., geographical location for example including longitude and latitude coordinates) or relative location of a respective client 14 with respect to a beacon 28 (e.g., distance between the client 14 and a beacon 28) in illustrative embodiments.

Location verification system 26 is provided according to one embodiment to verify locations of clients 14 with respect to location information provided regarding the locations of clients 14. In some embodiments, location verification system 26 may communicate with clients 14 to implement verification operations. For example, location verification system 26 may communicate directly with clients 14 and/or via a beacon 28.

In one embodiment, individual beacons 28 may be positioned at respective geographical locations wherein clients 14 will be expected to request data content of media repository system 12. At least some beacons 28 may be located remotely with respect to media storage system 22, rights management system 24, and/or location verification system 26. Individual beacons 28 may comprise communications devices configured to provide and/or verify location information of the clients 14. In one embodiment, beacons 28 may be configured to provide wireless, audio, infrared or other communications in a relatively limited geographical area (e.g., a radius of 50 feet or less from individual beacons 28). The communications range of individual beacons 28 may correspond to a usage rights area for consumption of the media content (e.g., coffee house, airport work area, etc. enabled with HP HearMusic) to implement the verification operations. In at least one embodiment, beacons 28 may individually have respective identification information to permit one or more of systems 22, 24, and/or 26 to authenticate the respective beacons 28 (e.g., using public key infrastructure). A list of authentic beacons 28 and other information (e.g., location, range, type, etc.) may be made available to systems 22, 24, and/or 26.

As discussed above, media repository system 12 may control access and consumption of media data items based upon location information of clients 14. Media repository system 12 may assign location based usage rights which control the consumption of the media content by a respective client 14 in different ways. For example, the usage rights may range from no restrictions regarding consumption (e.g., content of a media data item comprising a song may be-played and/or copied by a client 14) to any desired restriction (e.g., content may only be played and not copied by a client 14). In one embodiment, the usage rights may dynamically change if the location of the client 14 changes during the consumption, for example, if a user enters a store from the outside then additional usage rights may be granted.

According to one operational embodiment, clients 14 provide location information regarding the locations of the clients 14 to media repository system 12. For example, a client 14 may submit a content request to media storage system 22 which identifies a media data item which the user of client 14 wishes to consume. In one embodiment, the content request may comprise location information identifying a location of client 14 and which may be accessed and processed by system 12. For example, clients 14 may include a global positioning system (GPS) or assisted GPS (e.g., available on clients 14). In another example, course location information may be inferred from an electronic address (e.g., IP address) of clients 14. In another embodiment, a client 14 may obtain a location identifier (e.g., absolute or relative identifier) of the location information when the client 14 enters a location wherein access to media content is desired (e.g., using a magnetic swipe card co-located at the desired location) and the client 14 may communicate the location identifier to the media repository system 12 to provide location information to the system 12. In another embodiment, beacons 28 may communicate the location identifier to clients 14 co-located with beacons 28 for subsequent communication to system 12 to provide the location information.

Other embodiments are possible for communicating location information to system 12. For example, if no suitable location information is communicated with a content request for media content from a client 14 or for other reasons, media repository system 12 may reply with a location request to the client 14 requesting that the client 14 provide location information. In response to receiving the location request, client 14 may communicate location information (e.g., geographical location information) to the system 12.

Media repository system 12 may proceed to utilize the received location information to determine usage rights for providing access to and consumption of a requested media data item, or may alternatively proceed to verify the location information prior to determining the usage rights or permitting access. According to exemplary embodiments described below, usage rights system 20 may implement ping-type verification operations to verify location information. Other types of verification may also be performed.

In one exemplary verification implementation, location verification system 26 and beacons 28 may be configured to implement verification operations with respect to clients 14 co-located with respective beacons 28. In one possible implementation, beacons 28 may comprise radio frequency identification device (RFID) readers to verify location information of co-located clients 14. For example, clients 14 may be individually provided with a unique identifier and may operate as a transponder to provide the unique identifier to a respective beacon 28 responsive to polling from the beacon 28 to verify the client 14 being co-located with respect to the beacon 28 (i.e., within a relatively limited communications range of one of the beacons 28) responsive to a content request from the client 14. The failure of client 14 to respond with an appropriate identifier as detected by the respective beacon 28 may indicate a failed verification operation wherein streaming of media content to the client 14 may be prevented, ceased and/or other action taken.

In another possible embodiment, location verification system 26 may communicate a unique confirmation identifier (e.g., token) to a client 14 via a respective beacon 28 co-located with the client 14. Client 14 may be configured to thereafter communicate or pass the unique confirmation identifier to media storage system 22 as evidence of the location of the client 14 within the range of beacon 28.

In one embodiment, location verification system 26 may communicate a unique confirmation identifier to both client 14 and media storage system 22. Media storage system 22 may compare a unique confirmation identifier received from client 14 with identifiers received from beacons 28 to verify the location of the client 14 according to this embodiment. In another example, a unique confirmation identifier may be communicated to a requesting client 14 who may have to communicate the identifier to usage rights system 20 (e.g., via a respective beacon 28) within a predefined amount of time to be granted usage rights. Other embodiments are possible.

Other embodiments are possible for verifying location information of clients 14. For example, a confirmation identifier (e.g., token) may, be provided to clients 14 upon entry or presence at a location wherein access to media content is desired (e.g., using a magnetic swipe card, or other arrangement). When presented with a location request, respective clients 14 may reply with the confirmation identifier to the usage rights system 20 to enable the verification.

The beacons 28 may be provided at fixed locations in one embodiment to provide location information of one or more client 14 which are located at the locations of the respective beacons 28. As described above, the beacons 28 may be used to provide and/or verify the location information of clients 14 communicating with the respective beacons 28. The location information provided may correspond to the geographical locations of the respective beacons 28 in one embodiment. According to additional aspects, distance between a client 14 and a respective beacon 28 may be used to determine usage rights allocated to the client 14 (e.g., distance from a center of a canonical location). For example, the beacon 28 may count a period of time between the outputting of a signal and the return of a reply from a client 14 to determine the distance between the client 14 and the beacon 28 and thereafter the distance information may be used to determine the usage rights (e.g., if a beacon 28 is located at a store, such as a coffee shop, a client 14 in the shop may be granted additional usage rights of media content compared with another client 14 located outside of the shop). Exemplary possible different usage rights based upon distance may include “copy never” instead of “copy twice” for a respective media data item or allowing access to newer material the closer the user gets to the beacon 28.

According to some aspects of the disclosure described above, verification operations with respect to the location information of a client 14 may occur prior to permitting the client 14 to access the media content. According to additional aspects, media repository system 12 may verify location information of the client 14 during consumption of the media content by the client 14. A beacon 28 may be configured to poll the respective client 14 consuming media content for a period of time (e.g., at desired intervals) to verify the location information of the client 14 for continuing to provide the media content to the client 14. More specifically, system 12 may be configured to continue to provide content to a client 14 for a period of time while verification of the client 14 remaining at the appropriate location is determined, and system 12 may cease provision of the, content or access to the content if the client 14 is not verified by the respective beacon 28 as being present at the appropriate location according to one embodiment.

As mentioned above, beacons 28 may be positioned at different geographical locations corresponding to designated areas wherein media content may be consumed in accordance with some embodiments. According to additional aspects, one or more of the beacons 28 may be portable to provide verification operations of clients 14 in different geographical locations. In one exemplary video gaming application, a user may take their respective beacon 28 to another user's location (i.e., wherein another beacon 28 may be present) and the verification operations may entail verifying that the clients 14 are within appropriate ranges of their respective beacons 28 to continue to receive data content.

In another example, a composition policy may also be implemented to control the usage rights if one client 14 communicates with plural beacons 28 at a common location and the beacons 28 have different associated usage rights for a given media data item (e.g., different rights depending upon contracts, licenses, payment levels, etc.). Exemplary policies may include most restrictive wins, least restrictive wins, most recent wins, etc. Thereafter, requested media content may be communicated in accordance with the usage rights determined by the policy.

In other illustrative examples, portable beacons 28 may be used to extend rights for consumption upon airplanes, automobiles or in other applications wherein it is desired to grant rights as long as the location of client 14 is the same as a reference location (e.g., portable beacon 28). A user may take portable beacons 28 with themselves during travel to access media. Limits may; be provided on media content which may be consumed during portable consumption of media content outside of a home area in some embodiments.

As a result of the receipt of location information and/or positive verification analysis of the location information, media repository system 12 may apply usage rights assigned to a respective location to requested media content and communicate the media content of a selected media data item to the respective client 14 for consumption according to the usage rights. For example, responsive to the location of the requesting client 14 being verified, rights management system 24 may provide media storage system 22 with location based usage rights. Media storage system 22 may communicate the media content to the client 14 for consumption based upon the location based usage rights provided by system 24 in one example.

In one embodiment, requested media content may be communicated in accordance with the respective determined usage rights (e.g., only a portion of media content may be communicated and other portions retained within system 12 as permitted by the usage rights). Accordingly, in one embodiment, the determined usage rights may control the communication as well as the consumption of media content by the client 14. In another embodiment, an entirety of the requested media content may be communicated to the client 14 and the usage rights may control the consumption of a portion or an entirety of the media content by the client 14.

According to an additional exemplary aspect, access to media content of media repository system 12 may also be determined according to a location of repository system 12 or a location of one or more components of repository system 12. In one embodiment, media storage system 22 may be portable (e.g., portable media source with 1 TB hard disk of encoded content). Based upon the location of the media storage system 22, different usage rights may be granted by rights management system 24 to clients 14 desirous of accessing the media content based upon different locations of media storage system 22 (e.g., play once, play no-pause, etc.). Monitoring of location of media storage system 22 may be provided by internal location determination circuitry (e.g., GPS circuitry), usage of beacons 28, etc. Usage based rights determined by a location of media storage system 22 may be implemented alone or in addition to usage rights based upon locations of clients 14 as described above.

Additional aspects of the disclosure may specify usage rights after a client 14 leaves a location wherein the media content was accessed and previous user rights specified. For example, after original registration at a location whereupon user rights may be assigned, a respective client 14 may retain some rights after the client 14 leaves the location. Control of the rights may be based upon different parameters, such as enabling access for a predetermined amount of time after the client 14 exits the location, a predetermined distance from the location, etc. For instance, usage rights may initially be considered to be “fully charged” and leak away (e.g., decrease access or decrease rights) once a user leaves a respective location. Further, the media consumption experience of a client 14 may also be controlled by system 12 to be gracefully degraded or transition may be provided if location-rights change as a client 14 moves away from an absolute location or away from a beacon 28. For example, if the consumed media data item is a song, the song may fade away as opposed to being abruptly cut off as a user exits a location wherein the media data item was being consumed.

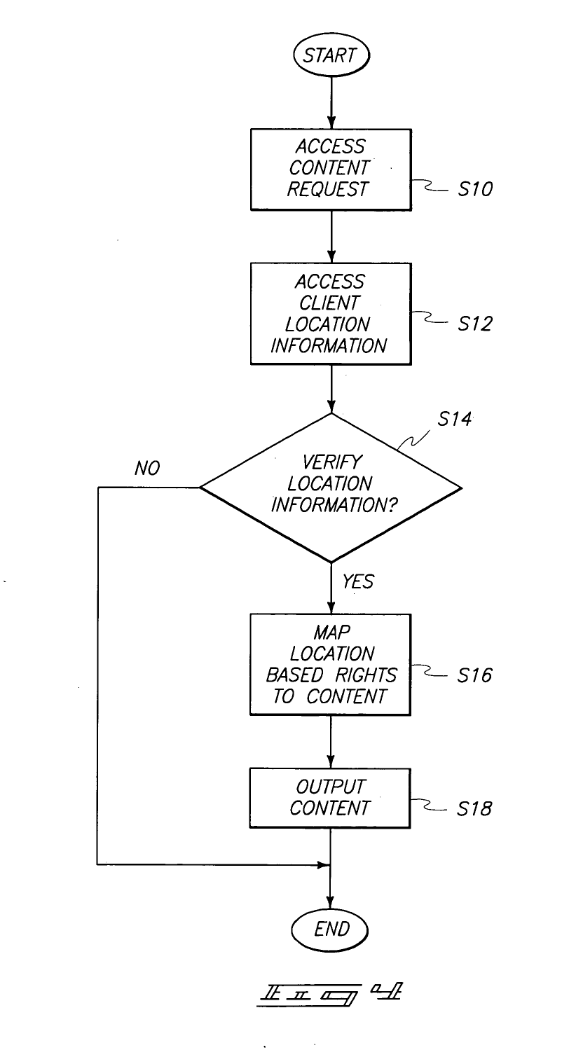

Referring to FIG. 3, exemplary circuit components of media repository system 12 are illustrated according to one embodiment for implementing the operations of system 12 described with respect to the functional description of FIG. 2. The exemplary embodiment of FIG. 3 includes a communications interface 30, processing circuitry 32, and storage circuitry 34. Other configurations are possible in other embodiments. Although not shown, individual ones of clients 14 may be configured similarly to the exemplary illustrated circuitry of media repository system 12 shown in FIG. 3.

Communications interface 30 is configured to implement communications external of media repository system 12 for example with respect to clients 14. Communications interface 30 may include a network interface to provide networked communications (e.g., private and/or public) in one network embodiment to provide communications with clients 14. In addition, communications interface 30 may include beacon 28 configured to provide communications with respect to clients 14. Communications interface 30 may include any appropriate arrangement to implement communications of system 12 with respect to external devices including clients 14. In one embodiment, communications interface 30 may receive content requests from clients 14, and output location requests and/or media content to clients 14.

In one embodiment, processing circuitry 32 is arranged to access and process data and to control operations of system 12. In a more specific example, processing circuitry 32 may process communications including, media content requests, access location information of clients 14, implement verification operations of location information of clients 14, assign usage rights based upon locations of clients 14, control media content access, media content storage, streaming of media content to clients 14, issue commands, and control other desired operations of media repository system 12 as described herein.

Processing circuitry 32 may comprise circuitry configured to implement desired programming provided by appropriate media (e.g., processor-usable media) in at least one embodiment. For example, the processing circuitry may be implemented as one or more of a processor and/or other structure configured to execute executable instructions including, for example, software and/or firmware instructions, and/or hardware circuitry. Exemplary embodiments of processing circuitry 32 include hardware logic, PGA, FPGA, ASIC, state machines, and/or other structures alone or in combination with a processor. These examples of processing circuitry 32 are for illustration and other configurations are possible. For example, if media storage system 22 and rights management system 24 are configured as respective servers, processing circuitry 32 may be embodied as a plurality of processors of the servers.

The storage circuitry 34 is configured to store electronic data, programming such as executable instructions (e.g., software and/or firmware), media content (e.g., content of plural media data items), media content of one or more media data items or other digital information and may include processor-usable media. Processor-usable media includes any article of manufacture which can contain, store, or maintain programming, data and/or digital information for use by or in connection with an instruction execution system including processing circuitry in the exemplary embodiment. For example, exemplary processor-usable media may include any one of physical media such as electronic, magnetic, optical, electromagnetic, infrared or semiconductor media. Some more specific examples of processor-usable media include, but are not limited to, a portable magnetic computer diskette, such as a floppy diskette, zip disk, hard drive, random access memory, read only memory, flash memory, cache memory, and/or other configurations capable of storing programming, data, or other digital information.

As mentioned above, individual clients 14 may be configured using hardware similar to the exemplary above-described arrangement of system 12 described with respect to FIG. 3. In addition, clients 14 may include additional components corresponding to the given arrangement of the clients 14. For example, if a client 14 includes a PDA or cellular telephone, an appropriate display and user interface may be provided.

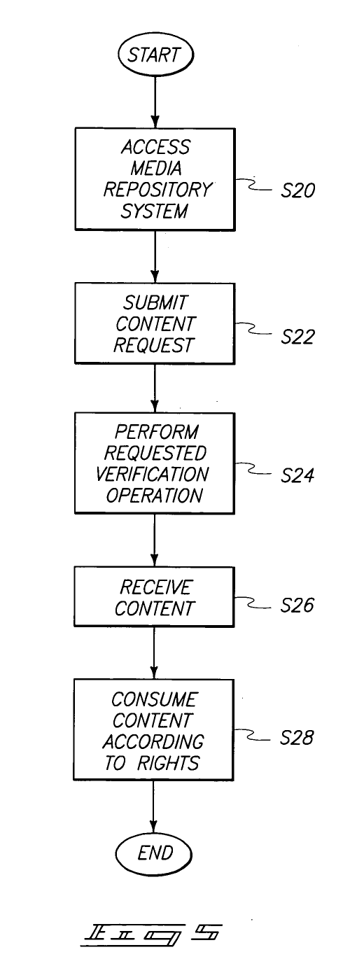

Referring to FIG. 4, an exemplary method performed by processing circuitry of media repository system 12 according to one embodiment is shown. Other methods are possible including more, less or alternative steps.

At a step S10, the processing circuitry accesses a media content request provided by a client. In one aspect, the processing circuitry identifies one of the media data items responsive to the media content request.

At a step S12, the processing circuitry accesses location information of the respective client which communicated the content request.

At a step S14, the processing circuitry attempts to verify the location information of the client.

If the condition of step S14 is negative, the process may end and access to the requested media content may be entirely or partially restricted.

If the condition of step S14 is affirmative, the process may proceed to a step S16 wherein usage rights for the requested media content may be ascertained based upon the location information and mapped to the requested media content to control the consumption of the media content.

At a step S18, the processing circuitry may control the media repository system to communicate the requested media content to the requesting client for consumption in accordance with the determined location based usage rights. The media content may be copied to the client, streamed via network or other data connections or otherwise made available to the client in exemplary embodiments.

Referring to FIG. 5, an exemplary method performed by processing circuitry of a client 14 according to one embodiment is shown. Other methods are possible including more, less or alternative steps.

At a step S20, the client may establish a data connection with respect to the media repository system.

At a step S22, the client may submit a content request for media content of one or more media data items to the media repository system. Location information regarding the location of the client may be provided to the media repository system along with the content request, or may be provided to or otherwise ascertained separate from the content request as described above.

At a step S24, the client may perform a requested verification operation with respect to verification of the location of the client. For example, the client may communicate location information, a confirmation identifier, respond to a polling signal, etc. to assist with the verification of the location information confirming that the respective client is located at a position as indicated by the location information.

At a step S26, the client may receive media content in accordance with the submitted content request.

At a step S28, the client may consume the media content according to the usage rights provided by the media repository system.

At least some aspects of the disclosure provide apparatus and methods which provide access to and/or consumption of media content based upon usage rights which may be granted to a rapidly changing and mobile user population. Location based usage rights may serve as a proxy for user authentication based rights for clients. Aspects of the disclosure enable a relatively straightforward specification of usage rights for media content including media content to be consumed in public locations, such as a coffee shop or other public location, where otherwise specifying that customers obtain rights to consume media content being streamed or otherwise made available may be considered too onerous.

The protection sought is not to be limited to the disclosed embodiments, which are given by way of example only, but instead is to be limited only by the scope of the appended claims.

1. A data access method comprising:
storing media content using a media repository system and wherein a plurality of different usage rights are provided for controlling the consumption of the media content;
using the media repository system, accessing location information regarding a location of a client configured to consume the media content;
using the location information, selecting one of the usage rights; and
communicating the media content to the client using the media repository system to be consumed in accordance with the one of the usage rights.

2. The method of claim 1 further comprising:
using the client, accessing a location identifier at the location wherein the media content is to be consumed by the client; and
communicating the location identifier from the client to the media repository system, and wherein the accessing the location information comprises accessing the location information comprising the location identifier.

3. The method of claim 1 further comprising verifying the location information using the media repository system responsive to the accessing, and wherein the communicating is responsive to the verifying.

4. The method of claim 3 wherein the verifying comprises:
communicating a confirmation identifier to the client using a communications device corresponding to the location of the client;
receiving the confirmation identifier using the client; and
using the client, communicating the confirmation identifier to the media repository system after the receiving, and wherein the media repository system uses the confirmation identifier for the verifying.

5. The method of claim 4 wherein the communicating comprises communicating the confirmation identifier to a media storage system using the communications device, and the verifying comprises, using the media storage system, comparing the confirmation identifiers received from the client and the communications device with one another.

6. The method of claim 1 further comprising, using the client, providing the location information at a moment in time when the client is desirous of consuming the media content and corresponding to the location of the client at the moment in time.

7. The method of claim 1 further comprising providing a content request for the media content using the client, and wherein the accessing comprises accessing the location information from the content request.

8. The method of claim 1 further comprising providing a content request for the media content using the client, and wherein the accessing the location information comprises:
providing a location request to the client responsive to the providing of the content request; and
providing the location information to the media repository system responsive to the providing of the location request.

9. The method of claim 1 further comprising:
verifying that the client is present at the location for a period of time; and
continuing to communicate the media content to the client for the period of time responsive to the verifying indicating that the client is present at the location.

10. The method of claim 1 wherein the storing comprises storing using a media storage system of the media repository system, and further comprising providing location information regarding a location of the media storage system, and wherein the selecting the one of the usage rights is responsive to the location of the media storage system.

11. The method of claim 1 wherein the accessing comprises accessing the location information using a beacon.

12. The method of claim 11 further comprising:
associating the different usage rights with different distances of the client with respect to the beacon; and
determining the location information comprising a distance of the client with respect to the beacon, and wherein the selecting the one of the usage rights comprises selecting responsive to the determining of the distance.

13. The method of claim 11 wherein the beacon is portable, and the location information comprises information of the location of the client with respect to the beacon.

14. The method of claim 1 wherein the accessing comprises accessing location information using a plurality of beacons having different usage rights associated with respective ones of the beacons, and further comprising implementing a policy using the media repository system responsive to the location information from the plurality of beacons, and the selecting the one of the usage rights comprises selecting according to the policy.

15. The method of claim 1 wherein the location information comprises geographical location information.

16. The method of claim 1 wherein the different usage rights are configured to control the processing of the media content by the client in respective different ways during the consuming.

17. The method of claim 1 wherein the media content comprises content of a plurality of media data items, and further comprising, using the client, selecting one of the media data items for consumption and wherein the communicating comprises communicating the media content of the one of the media data items.

18. A media repository system comprising:
storage circuitry configured to store media content of a plurality of media data items;
a communications interface configured to communicate the media content of a selected one of the media data items to a client; and
processing circuitry configured to access location information regarding a location of the client, to identify one of the media data items to be accessed by the client, to select one of a plurality of different usage rights responsive to the location information and configured to control the consumption of the media content of the one of the media data items by the client, and to control the communications interface to communicate the media content of the one of the media data items to the client for consumption in accordance with the one of the usage rights.

19. The system of claim 18 wherein the processing circuitry is configured to verify the location information and to control the communication of the media content of the one of the media data items responsive to the verification of the location information.

20. The system of claim 19 wherein the processing circuitry is configured to access a confirmation identifier received from the client and to verify the location information using the accessed confirmation identifier.

21. The system of claim 20 wherein the communications interface is configured to receive a content request from the client and the processing circuitry is configured to control the communication of the confirmation identifier to the client responsive to the reception of the content request.

22. The system of claim 18 wherein the processing circuitry is configured to access the location information at a moment in time wherein the client is desirous of consuming the media content and the location information corresponds to the location of the client at the moment in time.

23. The system of claim 18 wherein the communications interface is configured to receive a content request from the client and the processing circuitry is configured to access the location information from the content request.

24. The system of claim 18 wherein the communications interface is configured to receive a content request from the client and the processing circuitry is configured to control the communication of a location request to the client responsive to the received content request, and the location information is received from the client responsive to the communication of the location request.

25. The system of claim 18 wherein the communications interface comprises a beacon configured to provide the location information.

26. The system of claim 18 wherein the location information comprises information of a geographical location of the client.

27. The system of claim 18 wherein the different usage rights are configured to control the processing of the media content of the one of the media data items in different ways during the consumption by the client.

28. A media system comprising:
media storage means for storing media content of a plurality of media data items capable of being consumed by a client;
client means for providing a content request for one of the media data items and for consuming media content of the one of the media data items;
user rights means for accessing location information regarding a location of the client means and for assigning one of a plurality of different usage rights to the one of the media data items responsive to the location information for controlling the consumption of the media content of the one of the media data items by the client; and
wherein the media content of the one of the media data items is provided from the media storage means to the client means for consumption by the client means in accordance with the assigned one of the usage rights.

29. The system of claim 28 wherein the user rights means comprises means for verifying the location information.

30. The system of claim 29 wherein the user rights means comprises beacon means for communicating with the client means for the verifying.

31. The system of claim 28 wherein the client means provides the location information responsive to the client means receiving a location request.

32. The system of claim 28 wherein the location information is obtained from the content request of the client means.

33. The system of claim 28 wherein the location information comprises information of a geographical location of the client means.

34. The system of claim 28 wherein the different usage rights comprise rights for controlling processing of the media content of the one of the media data items in respective different ways by the client means during the consuming.

35. An article of manufacture comprising:
media comprising programming configured to cause processing circuitry of a media repository system to:
access location information regarding a location of a client desirous of accessing media content of the media repository system;
identify one of the media data items to be accessed by the client;
select one of a plurality of different usage rights responsive to the location information and configured to control the consumption of media content of the one of the media data items; and
control communication of the media content of the one of the media data items to the client for consumption by the client in accordance with the one of the usage rights.

36. The article of claim 35 wherein the programming is configured to cause processing circuitry to verify the location information and to control the communication of the media content of the one of the media data items responsive to the verification of the location information.

37. The article of claim 35 wherein the programming is configured to cause processing circuitry to access a content request from the client and to access the location information from the content request.

38. The article of claim 35 wherein the different usage rights are configured to control the processing of the media content of the one of the media data items in different ways during the consumption by the client.

39. The method of claim 1 further comprising, using the client, consuming the communicated media content in accordance with the one of the usage rights.

40. The method of claim 1 wherein the different usage rights provide different restrictions with respect to consumption of the media content by the client.

41. The system of claim 18 wherein the different usage rights provide different restrictions with respect to consumption of the media content by the client.

42. The system of claim 28 wherein the different usage rights provide different restrictions with respect to consumption of the media content by the client.

43. The article of claim 35 wherein the different usage rights provide different restrictions with respect to consumption of the media content by the client.

44. The method of claim 1 further comprising moving at least one of the client and the media repository system with respect to the other during the communicating.

45. The method of claim 1 wherein the accessing location information comprises accessing location information indicative of the location of the client with respect to the media repository system.

46. The method of claim 45 wherein the selecting comprises selecting the one of the usage rights corresponding to a first location of the client with respect to the media repository system at a first moment in time, and further comprising selecting an other of the usage rights corresponding to a second location of the client with respect to the media repository system at a second moment in time, wherein the first and second locations are different and the one and the other usage rights are different.

47. The method of claim 1 wherein the client and the media repository system are not physically connected with one another during the accessing, the selecting, and the communicating.

48. The method of claim 1 wherein the usage rights correspond to respective ones of a plurality of different locations of the client with respect to the media repository system.

49. The method of claim 1 wherein the client comprises one client, and further comprising:
providing an other client; and
communicating media content to the other client simultaneously with the communicating the media content to the one client.

50. The system of claim 18 wherein the processing circuitry is configured to access the location information indicative of the location of the client with respect to the media repository system.

51. The system of claim 50 wherein the processing circuitry is configured to select the one of the different usage rights corresponding to a first location of the client with respect to the media repository system and to select an other of the different usage rights corresponding to a second location of the client with respect to the media repository system, wherein the first and second locations are different and the one and the other usage rights are different.

52. The system of claim 18 wherein the communications interface is not physically connected with the client during the accessing of the location information and the communication of the media content.

53. The system of claim 28 wherein the usage rights means comprises means for accessing the location information regarding the location of the client means with respect to the media storage means.

54. The article of claim 35 wherein the programming is configured to cause processing circuitry to access the location information comprising information regarding the location of the client with respect to the media repository system.

55. The article of claim 55 wherein the different usage rights correspond to different locations of the client with respect to the media repository system.
